(19) United States
(12) Patent Application Publication
(10) Pub. No.: US 2024/0375976 A1
(43) Pub. Date: Nov. 14, 2024

(54) SINGLE-STAGE WATER TREATMENT SYSTEM

(71) Applicant: Clark Technology, LLC, Minneapolis, MN (US)

(72) Inventor: Kazem Eradat Oskoui, Maple Grove, MN (US)

(21) Appl. No.: 18/444,085

(22) Filed: Feb. 16, 2024

Related U.S. Application Data
(63) Continuation of application No. 18/365,636, filed on Aug. 4, 2023, now abandoned.
Application No. 18/365,636 is a continuation of application No. 16/782,597, filed on Feb. 5, 2020, now abandoned.
Application No. 16/782,597 is a continuation of application No. 14/815,130, filed on Jul. 31, 2015, now abandoned.
(60) Provisional application No. 62/031,481, filed on Jul. 31, 2014.

(51) Int. Cl. C02F 1/44; B01D 61/20; B01D 63/06; B01D 65/00; C02F 103/06

(52) U.S. Cl. CPC C02F 1/444; B01D 61/20; B01D 63/06; B01D 65/00; C02F 1/44; B01D 2313/025; B01D 2313/21; B01D 2315/00; C02F 1/441; C02F 2103/06; C02F 2209/40

(57) ABSTRACT

A single-stage water treatment system may include a fine filtration module configured for receiving process material with a high suspended and/or dissolved solids content and for producing a concentrate and a permeate. The fine filtration module may include an elongate housing member, a plurality of tubular membranes arranged within the elongate housing member and comprising elongate tubular members having membranous sidewalls with a selected permeability, a pair of end caps configured for controlling the flow of the process material within the plurality of tubular membranes, and an adjustment mechanism configured to adjust the elongation of the plurality of tubular membranes thereby adjusting the permeability thereof.

### CROSS-REFERENCE TO RELATED APPLICATION

The present application claims priority to U.S. Provisional Patent Application No. 62/031,481 entitled High-Solids, Single-Pass, Graduated Waste Water Treatment Apparatus and Method, filed on Jul. 31, 2014, the content of which is hereby incorporated by reference herein its entirety.

### FIELD OF THE INVENTION

The present disclosure relates to water and/or wastewater treatment systems. In particular, the present disclosure relates to filtration-based water treatment systems for treating high solids wastewater, leachate from sanitary or industrial landfills, manufacturing effluent, or other liquids carrying undesirable material or chemicals. Still more particularly, the present disclosure relates to single-stage tubular membrane filtration systems that may avoid the need for pre-filtration, aeration or chemical treatment.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Water and wastewater treatment systems, generally, have been around for hundreds of years. More recently, several stage systems have been implemented that involve a series of relatively sophisticated systems to treat particularly high solid and multi-contaminant streams. In some cases, for example, a system may include 4, 5, 6, 7, or more stages. For example, some multi-stage systems may begin with a coarse filter followed by stages that include an anaerobic digester and an aerobic digester. These systems may further include a sand filter stage, a cartridge filter stage, and an activated carbon filter. These systems may end with a fine filter process such as a microfiltration process including a micro screen or other fine filter processes including a membrane filter performing ultrafiltration, nanofiltration, or a reverse osmosis process to remove finer and dissolved contaminants. Having performed all of these processes, the liquid leaving the fine filter process may be suitable for placing back into lakes, rivers, or streams, or may even be potable.

It is to be appreciated that these several stage systems can be costly and can also be difficult and expensive to both operate and maintain. As a society faced with continuing population growth and an ever growing need for clean water, systems that are less expensive or at least are easier to operate and maintain may be desirable.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

In one embodiment, a single-stage water treatment system may include a fine filtration module configured for receiving process material with a high suspended or dissolved solids content and for producing a concentrate and a permeate. The fine filtration module may include an elongate housing member, a plurality of tubular membranes arranged within the elongate housing member and comprising elongate tubular members having membranous sidewalls with a selected permeability. The fine filtration module may also include a pair of end caps configured for controlling the flow of the process material within the plurality of tubular membranes and an adjustment mechanism configured to adjust the elongation of the plurality of tubular membranes thereby adjusting the permeability thereof.

In another embodiment, a method of providing water treatment may include receiving process material having a very high solids content and having suspended solids approaching ½ inch in spherical diameter. The method may also include directing the process material to a fine filtration process including routing the process material through a plurality of tubular membranes having a selected permeability. The process material being processed at a rate ranging from approximately 100 feet per second to approximately 350 feet per second. The method may also include capturing and routing a concentrate from the fine filtration process and capturing and routing a permeate from the fine filtration process.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a schematic diagram of a treatment system, according to one or more embodiments.

FIG. 2 is a process flow diagram of a treatment system, according to one or more embodiments.

FIG. 3 is a piping and instrument diagram of the treatment system of FIG. 2, according to one or more embodiments.

FIG. 4 is a perspective view of the treatment system of FIGS. 1-3, according to one or more embodiments.

FIG. 5A is a side view of a graduated filtration module of the system of FIGS. 1-4, according to one or more embodiments.

FIG. 5B is an end view thereof, according to one or more embodiments.

FIG. 6A is a side view of a casing and filtration portion of the module of FIGS. 5A and 5B, according to one or more embodiments.

FIG. 6B is an end view thereof.

FIG. 7A is a side view of the filter of the module of FIGS. 5A-6B, according to one or more embodiments.

FIG. 7B is an end view thereof.

FIGS. 8A, 8B, and 8C, are front, right side, and left side views, respectively, of an end cap, according to one or more embodiments.

FIGS. 9A, 9B, and 9C, are front, right side, and left side views, respectively, of an end cap, according to one or more embodiments.

FIG. 10A is a portion of a method of operation of the system, according to some embodiments.

FIG. 10B is a remaining portion of a method of operation of the system, according to some embodiments.

### DETAILED DESCRIPTION

The present application, in some embodiments, relates to water and wastewater treatment systems for treating various different types of wastewater such as municipal wastewater, leachate from sanitary or industrial landfills, manufacturing effluent, or other liquids in need of cleaning or separation. In other cases, the system may be used to pull water from a source of unusable water and filter it to produce useable water. In particular embodiments, the present application relates to a single-stage filtration system allowing waste water containing a high degree and size of solids to be input directly into the filtration system and treated without the use of multiple stages. The filtration system, in some embodiments, includes pass-through type tubular membrane filters that allow unfiltered material to pass through the system as a concentrate while allowing clean water to permeate through the membranes. The system may be run at a speed far exceeding the speed of other filtration systems causing the debris in the fluid to clean the filter without the need for back-flushing or backwashing. Still further, the system may include an adjustment mechanism to change the degree of filtration allowing for operators to continually accommodate changing conditions of incoming material without the need to exchange filtration membranes.

The present system is advantageous because, when compared to other multi-stage systems, it allows for feeding material directly to the fine filter stage of the system without the use of multiple stages of filtering and while avoiding clogging. That is, such an approach would have a tendency to clog other microfiltration, ultrafiltration, nanofiltration, and/or reverse osmosis type systems. Accordingly, a single-stage filtration system having fewer parts and pieces and allowing for the same or better level of filtration may be provided.

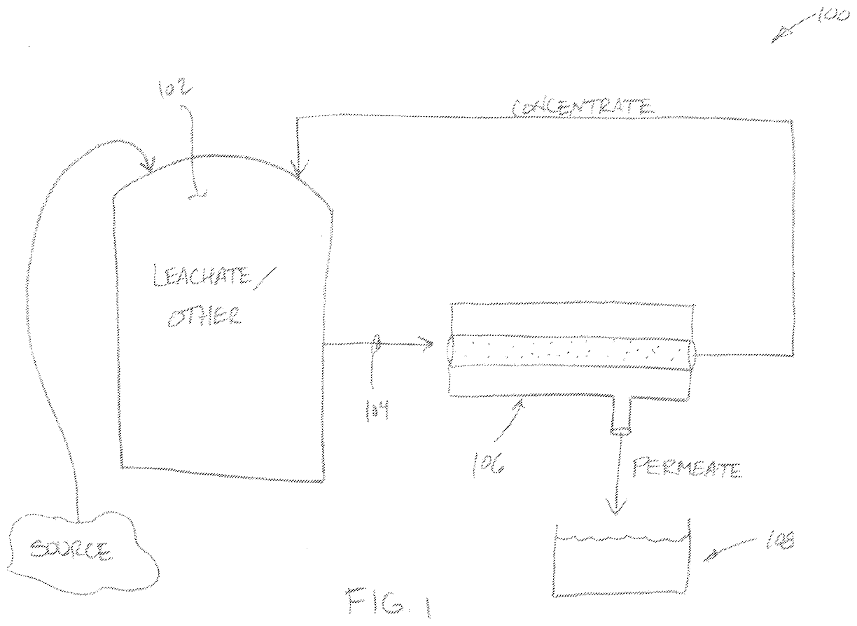

Referring now to FIG. 1, a schematic diagram of a single-stage system 100 is shown. The schematic diagram is arranged and configured for treatment of landfill leachate, but it is to be appreciated that other inputs can be accommodated. As shown, the system 100 may include a storage and/or staging portion 102, a pre-treatment portion 104, a fine filtration portion 106, and a collection portion 108. It is to be appreciated that storage and/or staging portion 102 may be provided to even out fluctuations in incoming flow, but where the incoming flow is relatively regular, the storage and/or staging portion 102 may be omitted. The system may also include an optional secondary treatment system and a storage system as shown in later Figures. As with the storage and/or staging portion 102, the secondary treatment and storage system may be omitted if readily available uses for the water from the system are available. The system 100 may be configured for multiple uses of the stored clean water such as supplying water to an infiltration basin, a hydroseed fill line, or a hose bib. Still other options for use of the water may be implemented.

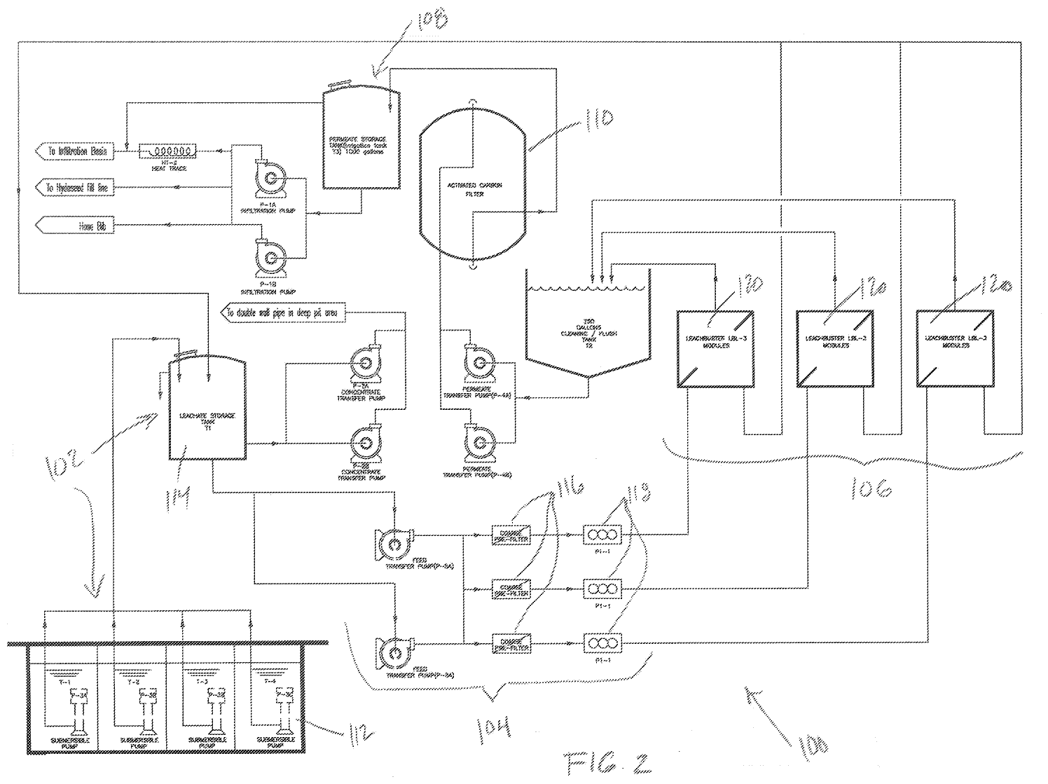

Referring now to FIG. 2, a more detailed process flow diagram of the filtration system 100 is shown. Like FIG. 1, the process flow diagram includes a storage and/or staging portion 102, a pre-treatment portion 104, a fine filtration portion 106, and a collection portion 108. As also shown, in this embodiment, an optional secondary treatment 110 is shown. Still further, multiple parallel pathways are shown that allow for scaling of the system for processing higher volumes of material and, in some embodiments, additional pumps or other features may be installed to accommodate future expansion and/or growth of the system.

In still further detail, a piping and instrumentation diagram is shown in FIG. 3. As may be appreciated, several of the same elements are shown in FIG. 3 as are shown in FIGS. 1 and 2. In FIG. 3, additional detail regarding the particular piping arrangements, valves, measurement devices, and the like are shown. The following discussion refers generally to FIGS. 1 and 2 and more detailed discussion of FIG. 3 is saved for later.

The storage and/or staging system 102 may include one or more collection tanks 112 and a process or concentrate tank 114. In other embodiments, just a process tank 114 is provided. As shown, the collection tanks 112 may be configured for ongoing collection of leachate. For example, the tanks 112 may be underground tanks 112 that are positioned and arranged to collect leachate from a landfill, for example. The tanks 112 may be in fluid communication with collection ditches, troughs, or drains, for example, and the tanks may regularly, intermittently, or continually collect leachate from the landfill. The collection tanks 112 may be sized to accommodate the amount of expected leachate in conjunction with the rate of treatment of the leachate. In some embodiments, the collection tank size may be selected based on the acreage of the landfill, for example, or may be sized to allow for a 2 hour retention time and an otherwise continuous flow, for example. The tanks 112 may include one or more pumps such as submersible pumps for ejecting the leachate. In the present embodiment, the pumps may be configured to pump the leachate from the collection tanks 112 to a process tank 114.

The process or concentrate tank 114 may be positioned in the treatment loop of the system 100. That is, while incoming leachate may be received from the collection tanks 112 or other source and placed into the system via the process or concentrate tank 114, the process tank 114 may also receive concentrate from the system itself. The process tank 114 may, thus, function as at least one gateway to the treatment system.

The process or concentrate tank 114 may be an elevated leg storage tank or another style tank may be used. The tank size may be selected based on system capacity and in some embodiments, may include a 2,000 gallon tank. The tank 114 may be in fluid communication with the collection tanks 112 and also in fluid communication with the treatment loop. An overflow outlet may be provided and a drain outlet may also be provided. The tank 114 may include an access hatch for human access to the tank for servicing and/or repair.

The pre-treatment portion 104 may include one or more feed pumps for advancing the leachate or other process material from the process or concentrate tank 114 or from the bypass of the process tank 114, through the pre-treatment portion 104 and to the fine filtration portion 106 of the system 100. The pumps may include high pressure pumps capable of producing pressures ranging from approximately 20 psi to 1000 psi, for example. Still other types and styles of pumps may be provided. In the present embodiment, two pumps are shown that supply material and pressure to three lines passing through the pre-treatment portion 104 of the system 100. However, most any combination of pumps and lines may be used to accommodate the volume of material being processed, future expansions, and the like.

The pre-treatment portion 104 may include a coarse pre-filter 116. For example, while the system 100 is a single-stage filtration system 100, it may have some basic limits on the size of material it is capable of processing. In some embodiments, the fine filtration system 100 may be sized and configured to accommodate material sizes up to A inch (i.e., the tubular membranes may be approximately % inch in diameter). Accordingly, the coarse pre-filter 116 may include a screen or strainer for catching material exceeding W inch. In some embodiments, a buffer may be provided and the coarse pre-filter 116 may be sized to catch material exceeding M inch. The pre-treatment portion 104 may also include a characterization component for assessing the nature of the material about to be processed. In some embodiments, various measurement devices may be present in the pre-treatment portion 104. For example, devices for measuring pH, conductivity, total dissolved solids (TDS), pressure, temperature, and the like may be provided.

As mentioned, the feed pumps may advance the leachate to the fine filtration portion 106 of the system 100. The fine filtration portion 106 of the system 100 may include one or more filtration modules 120 having elongate housing elements or casings 122 configured for housing a plurality of membrane filters 124 arranged therein and configured to collect permeate from those filters 124. The elongate housing element or elements 122 may include one or more end caps 126 for controlling the flow of the material through the membrane filters 124. The fine filtration portion 106 may also include a membrane adjustment system 128. The fine filtration system 106 may be configured to receive the influent leachate, cause water to permeate from the leachate as it passes through the membrane filter or filters 124, and selectively return the remaining fluid (i.e., concentrate) to the leachate process or concentrate tank 114. As will be shown, other intervening optional routes may be provided for the concentrate or the permeate.

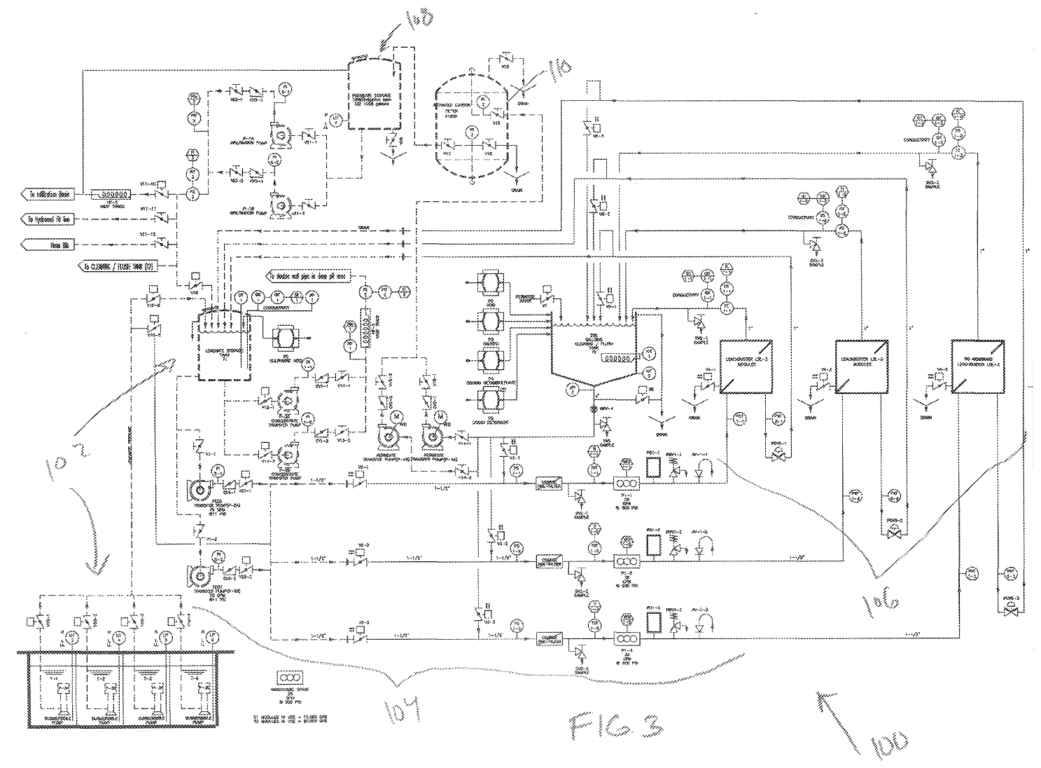

Referring now to FIG. 4, a perspective view of the treatment system is shown 100. As shown, like FIGS. 1-3, the system 100 may include a process or concentrate tank 114, a pre-treatment portion 104, a fine or graduated filtration portion 106, and a collection portion. As also shown, like FIGS. 2 and 3, the fine or graduated filtration portion 106 may include one or more filtration modules 120 comprising elongate housing elements or casings 122 with internal membrane filters 124. In the present embodiment, three filtration modules 120 are shown each having a series of elongate housing elements or casings 122.

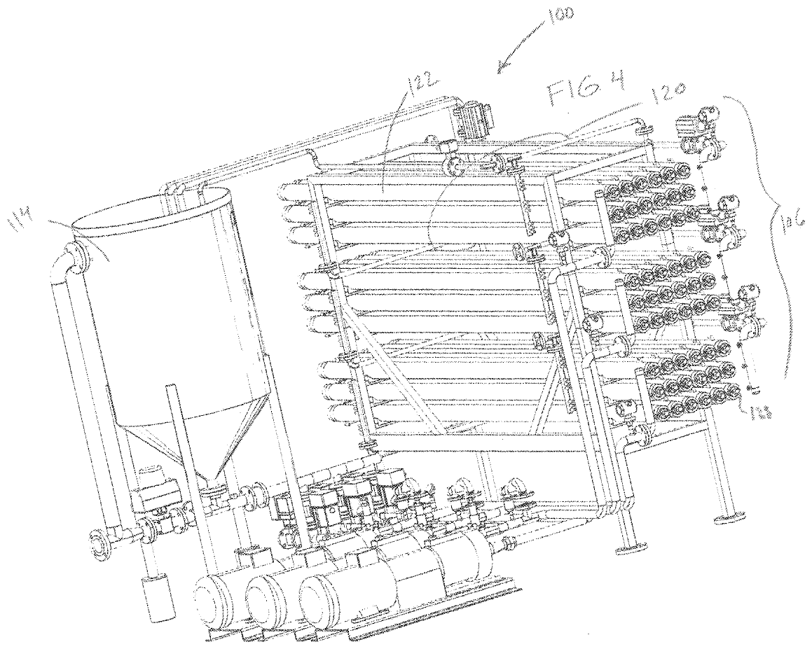

Turning now to FIGS. 5A and 5B, a side view and end view of a single housing element or casing 122 is shown. As shown, the housing element or casing 122 may include an elongate element having an internal cavity for containing membrane filters 124 and for collecting permeate from the membrane filters 124. As shown, the housing element 122 may include an elongate, cylindrically-shaped tube or pipe 130. The housing element 122 may include one or more permeate collection nipples or ports 132 for receiving permeate from the internal cavity and directing the permeate into a collection line, for example. The housing element or casing 122 may include a steel pipe and, in some embodiments, a stainless steel pipe or tube may be provided. In other embodiments, other materials may be used.

As mentioned, the elongate member 122 may house the plurality of tubular membranes 124, but it may also be configured to collect permeate coming from those membranes 124. That is, as shown in FIG. 1, as the material flows through tubular membranes, some portion of the material may permeate through the tubular membranes 124. The permeate may thus begin to fill the otherwise free space within the elongate member and may flow toward an outlet, spigot, hose bib, nipple, or other output element 132 arranged along the length of the elongate member 122 and passing through the wall of the elongate member 122. In some embodiments, a series of outlets may be provided along the length of the elongate member 122. In other embodiments, a single outlet may be provided at a low point of the elongate member 122 allowing gravity to draw the permeate toward the outlet. In still other embodiments, the permeate may be driven to the outlet due to the pressures within the elongate member 122 relative to the exiting permeate line, for example.

The housing element or casing 122 may include a pair of end washers 134 for abutting the housing or casing or a flange thereof. The end washers may grip the tubular membranes and allow the membranes to be sleeved therethrough. The end washers 134 may be configured to bias the end caps 126 relative to the housing 122 as discussed in more detail below. The end washers 134 may include substantially flat plate washers having an outer diameter slightly exceeding the inner diameter of the housing or casing 122 so as to abut the end of the housing or casing 122 without entering the housing or casing 122. The washers 134 may include an opening for each of the tubular membranes 124 and the openings may be arranged in a pattern matching that of the arrangement of the tubular membranes 124 within the housing or casing 122. The openings may each include a rubber or other resilient washer or grommet arranged in the opening so as to engage and seal the opening as a tubular membrane 124 extends through the openings in the washer 134. In the present embodiment, 18 tubular membranes 124 are shown and, as such, the end washers include at least 18 openings for receiving the tubular membranes 124. An additional opening is shown for a fastener and/or adjustment device.

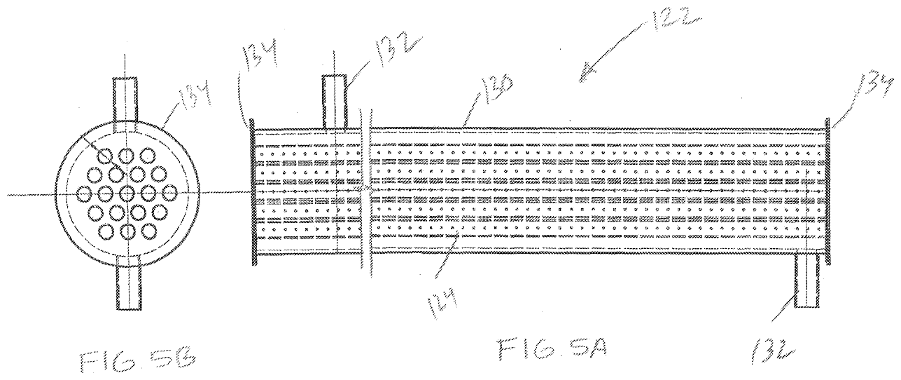

Turning now to FIGS. 6A and 6B, the housing or casing 122 with the internal tubular membranes 124 is shown without the end washers 134 and without the permeate collection ports 132. As shown, the radial position of the tubular membranes 124 in the internal cavity may be controlled by a pair of end bushings 136. That is, the end bushings 136 may include a plurality of openings defining the radial pattern of the tubular membranes 124 within the housing 122. The end bushings 136 may be fit within the housing or casing 122 so as to securely seat in the ends of the housing 122 creating a seal around the outer perimeter of the end bushings 136. This may be provided by a friction fit, a counter bore in the casing providing a seat for the end bushing, a wedge shaped end bushing, or other approaches. In some embodiments, the end bushing may include a flange extending outwardly so as to engage the end of the casing preventing the end bushing from translating through the casing once the flange engages the end of the casing. In addition, like the end washers 134, the openings in the end bushings 136 may include a rubber or other resilient washer or grommet arranged in the opening to engage the tubular membrane passing therethrough while allowing the tubular membrane to slide and also providing for sealing the opening. The perimeter seal of the end bushing 136 and the seal around each tubular membrane 124 may resist leakage of permeate from the housing 122.

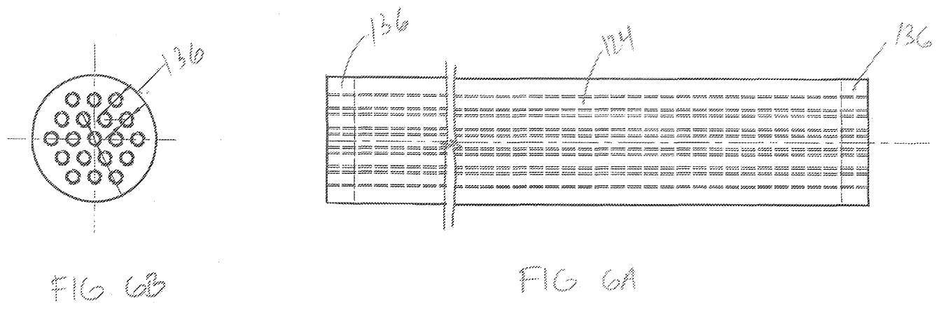

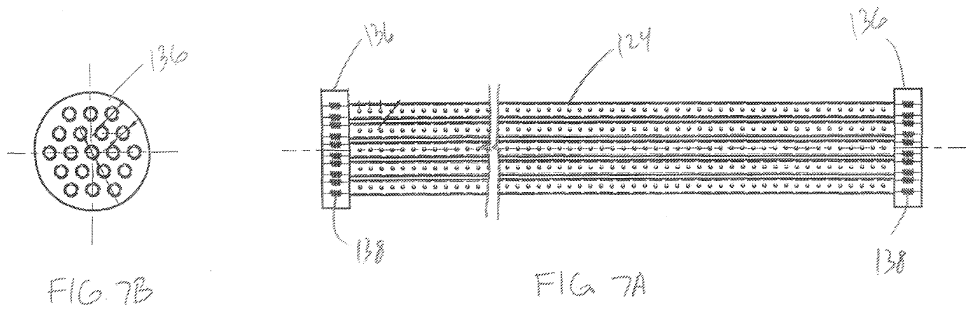

FIGS. 7A and 7B show the tubular membranes 124 in isolation from the housing 122 and with the end bushings 136 positioned on opposite ends thereof. As shown, the end bushings 136 may be configured to create a biasing force against the end washers 134 so as to press the end caps 126 outward relative to the housing 122 and create tension in the tubular membranes 124. That is, as mentioned, the end bushings 136 may be configured for secure fit within the ends of the housing 122. The end bushings 136 may also include one or a plurality of biasing elements 138 such as springs or other resilient elements positioned in the end bushings 136 and exposed on the outboard surface of the end bushing 136 to press against the neighboring element, such as the end washers 134. In some embodiments, the biasing mechanism may be provided by an air or other fluid-based pressure such as hydraulic pressure, for example. In still other embodiments, the biasing mechanism may be magnetically induced or otherwise induced by electrical charge or energy.

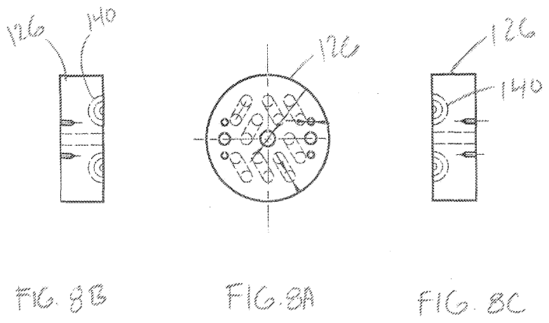

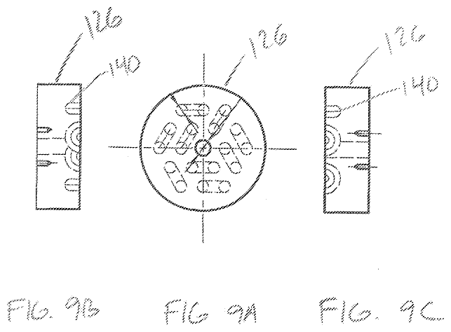

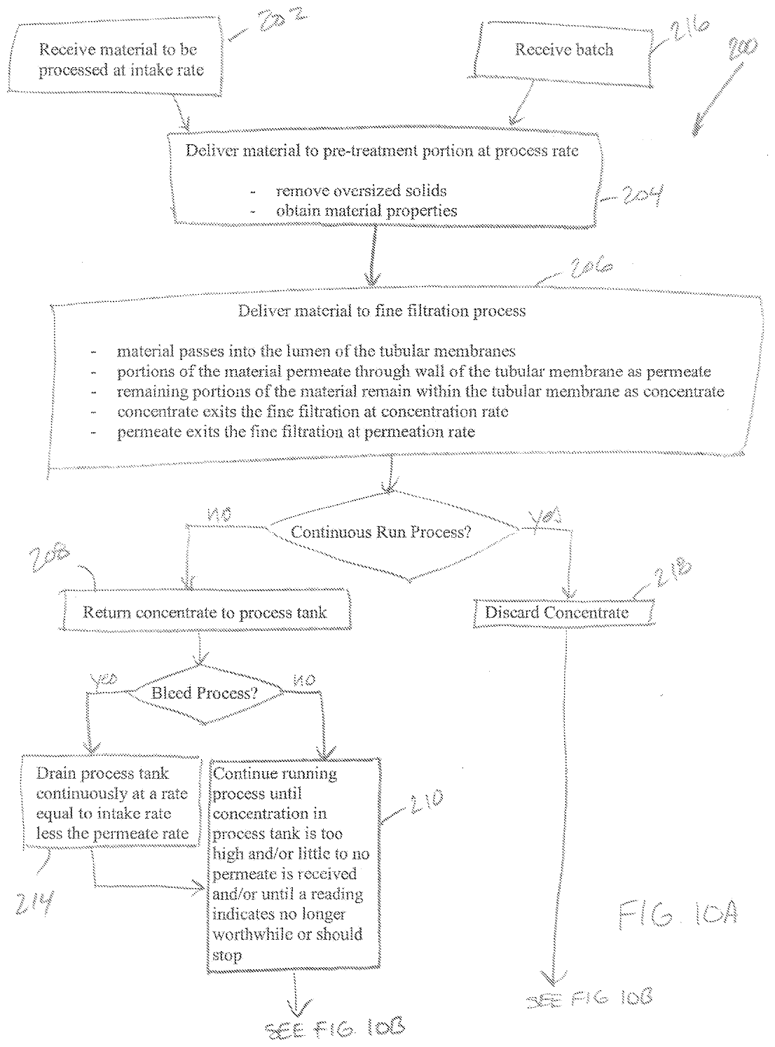

Turning now to FIGS. 8A-8C and 9A-9C, end caps 126 are shown. As shown, the end caps 126 may be configured to secure and/or grip the tubular membranes 124 as they exit the housing 122 and enter the cap 126. The end caps may be secured to the end bushing through the end washer with a fastener. As shown, the washer may extend through the center of the end cap. In other embodiments, the end cap may include a flange and an array of fasteners may be positioned around the perimeter of the end cap for securing the end cap and for adjusting the seating of the end cap against the end washer or other sealing system.

The end caps 126 may control the routing of fluid as the fluid reaches the end of the housing 122 in one tubular membrane 124 and is routed through the end cap 126 via one or more turn around paths 140 and into a different tubular membrane 124. That is, in some embodiments, the tubular membranes 124 may be configured to operate in series. In this embodiment, all of the incoming material directed to particular filtration module 120 may flow through a single tubular membrane 124 at the beginning of the elongate member 122, through the full length of the elongate member 122, and to the opposite end of the tubular membrane 124. The end cap 126 may then redirect the material to another tubular membrane 124 in the elongate member 122 sending the material the opposite direction through the elongate member 122 and through the full length of the second tubular membrane 124. This process may be repeated by the formation of the end caps 126 until each tubular membrane 124 in the elongate member has received the material and had it run through its full length. Still further, multiple elongate members 122 may be strung together in series to create a filtration system with any desired length. Consideration to the amount of space available, the desired level of filtration desired, and the effectiveness of looping the treatment may be given when deciding on the length of filtration to provide.

In other embodiments, the tubes 124 may be used in parallel where the incoming material is separated into the several tubular membranes 124 in the elongate member 122 and the material flows the full length of the respective tubular membrane 124 in which it entered and then exits the system having flowed through one of the several tubular membranes 124 in the system. In still other embodiments, two or more tubes 124 may be selected to receive the incoming material thereby defining a corresponding number of paths through the system. For example, if 18 tubular membranes are present in the elongate member 122 and two tubes are used to receive the incoming material, there may be 2 pathways through the system where each pathway includes 9 tubular membranes 124 connected in series. Still other approaches to using the tubular membranes 124 and providing corresponding end caps 126 may be provided.

The plurality of membrane filters 124 may include a plurality of tubular membrane filters. In some embodiments, the tubular membranes 124 may be arranged within the elongate housing 122 extending longitudinally along and within the housing and in a radial pattern about the longitudinal axis of the elongate housing 122 as shown. The tubular membranes 124 may be constructed of a material that is generally impervious to large molecules, but may allow relatively small molecules such as water to pass through. As such, small molecules flowing within the tubes may permeate through the wall of the tubular membranes 124, while larger molecules such as solids, organic matter, microorganisms, and other material inside the tubes may not. In particular, a pressure differential may be created across the membrane to encourage the flow of small molecules through the tube wall. In some embodiments, the tubular membranes may include polyamide film, cellulose acetate, modified polyethersulphone (modified PES), PES, polysulphone, polyvinylidene difluoride (PVDF), polyacrylonitrile, or another material that is impervious to relatively large molecules but allows smaller molecules to permeate through.

The membrane adjustment system 128 may be provided to allow the otherwise static filtration system to be dynamic or adjustable depending on the nature of the leachate or other influent and the desired permeate or water. That is, the filtration system 100 may have a selected tubular membrane 124 in it with a selected or defined filtration size base on the permeability of the selected material and other factors. Without more, the rate at which such a system may treat a particular leachate and the amount and size of the solids, organics, or other contents that remain in the concentrate may be determined in large part by the nature of the leachate, the pressures that are used to process the leachate, and the area of tubular membrane used. However, with an adjustment system 128, the nature of the clean water leaving the system (i.e., permeate) may be adjusted making the system more versatile than other presently known systems and allowing the operator to accommodate a desired or mandated output cleanliness while also accommodating demands for higher treatment volumes, etc.

The adjustment system 128 may include a combination of elements of the filtration system 100. For example, as mentioned above, the end bushings 136 may include biasing mechanisms 138 therein that may create a bias against the adjacently positioned end washers 134. In addition, as described, the end caps 126 may grip the tubular membranes 124. Accordingly, the biasing mechanism 138 in the substantially fixed end bushings 136 may create an outward force against the end plate 134 to cause the end caps 126 to pull outwardly on the tubular membranes 124 creating tension in the tubular membranes 124. The tension in the tubular membranes 124 may function to change the permeability of the membrane 124. For example, the tubular membranes 124 may be designed to be installed under a selected amount of tension. When installed under the selected amount of tension, the tubular membranes 124 may have a permeability defining a mean spherical diameter of the material allowed through the membrane 124. The bias present in the biasing mechanism 138 may be increased causing the tubular membrane 124 to be stretched beyond the selected amount of tension causing the orifices or other openings in the membrane 124 to be stretched (i.e., elongated) and more narrow than when the membrane 124 is under the selected amount of tension and, thus, the mean spherical diameter of the membrane 124 may decrease. In contrast, when the bias present in the biasing mechanism 138 is decreased to cause the tension in the tubular membranes 124 to be less than the selected tension, the shape of the orifices may become more round and may, thus, increase the mean spherical diameter of the orifices in the membrane 124. In some embodiments, a relaxed tubular membrane 124 may have orifices defining a mean spherical diameter of approximately 0.0005 micron, for example. When such membranes are stretched, the mean spherical diameter may be reduced to, for example, 0.00025 micron. To be clear, a relatively round orifice may have a mean spherical diameter approximately equal to the diameter of the orifice. When the membrane is stretched, the orifice takes on an elongated shape and the distance across the orifice decreases, thus, decreasing the size of the material that may pass through the orifice. By stretching and/or relaxing the membranes, the mean spherical diameter of the material that can permeate through the membrane can be adjusted. Still other tubular membranes having another permeability in a relaxed state may be provided.

The adjustment mechanism 128 may be configured for movements of a relatively small scale such as small fractions of an inch, microns, and the like. That is, very small changes in the elongation of the membranes 124 can affect the permeability of and have a relatively large effect on the resulting permeate. The adjustment system 128 may be adjusted using an external dial or knob that is calibrated to adjust the adjustment system based on the amount of rotation of the knob. In some embodiments, the external dial or knob may be the fastener that secures the end cap to the end bushing as shown in FIG. 4, for example. Where the end cap is provided with a flange, the adjustment system may include a series or plurality of fasteners arranged around the perimeter of the end cap. In either case, the rotation of the knob or knobs may result in translation of the end cap against or with the biasing force of the end bushing thereby adjusting the tension in the tubular membranes. In still other embodiments, the adjustment mechanism 128 may include a rack and pinion or other device for converting rotational motion to translation where, for example, the knob is positioned on the side of the casing. Still further, gears may be used such that a perceptible amount of rotation by the human hand results in very small potentially imperceptible translational motion of the adjustment mechanism. Still further, stops may be included so as to avoid over stretching the membranes in the system. In some embodiments, the adjustment mechanism 128 may be automatic based on readings observed by the system in comparison to desired properties. While the adjustment system has been described as a system for increasing or reducing longitudinal tension in the tubular membranes, still other methods of adjusting the permeability may be provided. For example, one end of the membranes may be twisted relative to the other end or other methods for stretching or relaxing the membranes may be provided.

The feed line leading to the filtration system 106 and the concentrate line and permeate line leaving the filtration system may each include a system of valves and/or pressure regulators to control the pressures and velocities experienced by the fluid within the filtration system. The feed line may be pressurized based on the pressures developed by the feed pumps. As the leachate enters and passes through the tube filter 124, the concentrate line may include a valve or regulator to control the pressure in the concentrate line and, thus, the upstream pressure within the filtration system 104. In addition, as permeate passes through the tube membrane wall to the permeate line, a valve or regulator may be present to control the pressures of the permeate at a pressure below that of the feed line and the concentrate line. In some embodiments, the permeate line may be at or near atmospheric pressure. In some embodiments, the feed line and concentrate line may have pressures ranging from approximately 20 psi to approximately 1000 psi and a velocity providing a flow of 200 gallons per minute, for example. That is, given an approximately % inch diameter tubular membrane, the velocity may range from approximately 100 to 500 feet per second or from approximately 100 to 400 feet per second or from approximately 100 to 350 feet per second. In some embodiments, a relatively slow velocity may be used for several hours (i.e., 20-22 hours per day) and a scour or cleaning speed may be used for the remaining hours (i.e., 2-4 hours per day). In these embodiments, the relatively slow velocity may be approximately 75 to 150 feet per second and the scour or cleaning velocity may be approximately 250 to 375 feet per second or approximately 300 to 325 feet per second, for example. In other embodiments, the running speed may be selected at 250 to 375 or 300 to 325 and used throughout. As may be appreciated, the velocity may far exceed the velocity used during reverse osmosis systems by a factor of 10, for example.

The permeate leaving the filtration system 106 may be substantially clean water safe for placement back into lakes, streams, and rivers. In some embodiments, the clean water is placed into a permeate storage tank and one or more lines may leave the storage tank and lead to facilities for using the permeate. For example, as shown, a line may extend to an infiltration basin and a heat trace may be provided to keep the line from freezing in winter conditions. Another line may lead to a hydroseed operation. In still other embodiments, a line may lead to a nearby hose bib or spigot for use in cleaning the systems or otherwise connecting a hose.

It is to be appreciated that over time, the concentration of the material in the process tank 114 may continue to increase due to the concentrate leaving the filtration module 106 and returning to the process tank 114. As shown, the process tank 114 may include a drain line for emptying and/or draining all or a portion of the material in the process tank 114. The drain line may include one or more concentrate pumps for advancing the concentrate through the drain line. In some embodiments, the drain line may lead to a pit area or deep pit area for permanent or semi-permanent storage of the concentrate. As may be appreciated, by draining the concentrate from the process tank 114, the concentration of the material in the process tank may return to a concentration more consistent with the incoming material, for example, leachate.

It is to be appreciated that the system 100 may be effective to produce clean water or water suitable for discharge into lakes, rivers, and streams. However, in some embodiments, the system may be paired with other systems for removal of particular items that may pass through the fine filtration process and remain in the permeate. For example, in some embodiments, where Boron or other elements are present in the permeate, the system may be used in conjunction with an activated carbon filter 110, for example. As shown, the permeate may leave the fine filtration process via permeate lines and be placed in a cleaning and/or flush tank, such as the 250 gallon tank shown. Permeate transfer pumps may be used to transfer the permeate to an activated carbon filter 110 before the permeate is placed in the permeate storage tank.

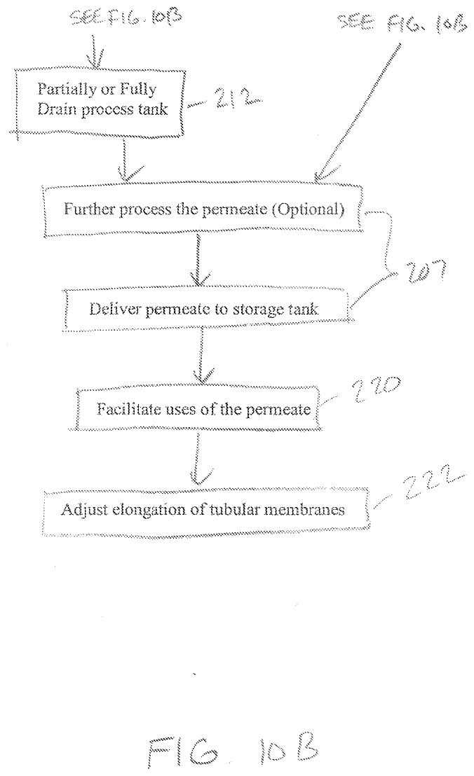

The above described system may be used to perform a process 200 such as treatment of landfill leachate, waste water, manufacturing effluent, process effluent, and the like. Still other materials may be processed using the system 100 described. The system may be used in several ways such as a topped batch process, a feed and bleed process, a true batch process, and a continuous run process, each of which take advantage of the pass-through approach of the fine filtration process 106. Still other methods of using the system may be provided. These four processes are discussed in more detail below with reference to FIGS. 10A and 10B.

### Topped Batch

In this process, the incoming material, such as leachate, may be pumped into the process tank 114 at a relatively regular or a regular rate defined as the intake rate. (202) The leachate in the process tank 114 may be pumped to the pre-treatment portion 104 at a rate defined as process rate. The leachate may pass through the pre-treatment portion by having large solids in the material removed by the coarse pre-filter and properties of the material may be obtained. (204) The leachate may then pass to the fine filtration process. As the leachate enters the fine filtration process, the leachate passes into the lumen of the tubular membranes and portions of the leachate may permeate through wall of the tubular membrane, while the remaining portions of the leachate may remain within the tubular membrane and exit the fine filtration process as a concentrate. (206) The permeate may be further processed or the permeate may be directly placed into a permeate storage tank. (207) As discussed above, the permeate may be used for various activities including watering, hydroseeding, washing, flushing, and other activities. (220) As also discussed above, the tubular member elongation may be adjusted to change the nature of the permeate. (222) The rate at which the permeate permeates through the tubular membrane may define a permeation rate and the rate at which the concentrate leaves the fine filtration system may define a concentrate rate. It is expected that the permeate rate and the concentrate rate may be summed to equal the process rate. That is, the volume of material entering the fine filtration process may be equal to the volume of material exiting the fine filtration process such that the incoming rate (process rate) is equal to the sum of the two outgoing rates (permeate rate and concentrate rate). As shown in the figures, the concentrate may be returned to the leachate storage tank and may be allowed to re-enter the system one or more additional times. (208) In this process, the intake rate of additional material may be adjusted to match the permeation rate, such that the volume of material in the system remains substantially constant.

However, as may be expected, the returning concentrate may increase the concentration of the process tank 114 and, as such, periodically, the drain of the process tank 114 may be opened to allow highly concentrated material to exit the process tank 114. (210) The drain may be opened such that the drain rate exceeds the intake rate less the permeate rate allowing the volume of material in the process tank to reduce. (212) The drain may then be closed and the intake increased such that the tank begins to fill and upon reaching a desired fullness, the intake may be adjusted to match the permeate rate once again. The system may again continue to run until the concentration in the tank is too high and the tank may again be drained.

### Feed and Bleed

In an alternative to the above described continuous run, the drain on the process tank may be opened continuously. In this case, the drain rate (i.e., bleed rate) may be adjusted such that the drain rate is approximately equal to the intake rate less the permeate rate or it may be adjusted to match the concentration rate. (214) In this manner, the volume of material in the process tank 114 may remain substantially constant. It is to be appreciated that while some bleeding of the process tank is provided, the concentration of the process tank may still increase and the tank may need to emptied or more fully bled from time to time. (210) As such, the feed and bleed process may be a way to spread out the times when the tank needs to be drained, but might not fully avoid this process.

### True Batch

In an alternative embodiment, a true batch process may be used. In this embodiment, a selected amount of material may be placed in the process tank. (216) The system may be activated like the topped batch process causing the material to go through the pre-treatment area and through the fine filtration process. (204)(206) The fine filtration process may result in a permeate (the material that permeates through the sidewall of the tubular membranes) and a concentrate (the material that flows through the tubular membranes, but does not permeate through the sidewall). The permeate may be further processed or the permeate may be directly placed into a permeate storage tank. The concentrate may be returned to the process tank for re-processing. (208) The batch may be continuously run until little to no permeate is received from the fine filtration process or until a reading at the process tank at the pre-treatment portion or other reading reveals that the process is no longer worthwhile or otherwise should be stopped. (210) At that time, the process tank may be drained and another batch may be provided to the system for treatment. (212) This type of process may be useful in a situation where a particular shift creates an amount of material that needs to be processed during off-shift hours, such as a slaughter house, for example.

### Continuous Run

In still another alternative embodiment, a process may be used where the concentrate is not returned to the process tank. This process may be similar to the topped batch process, but instead of returning the concentrate to the process tank resulting in a need to periodically or continually drain the process tank, the concentrate may be dumped or otherwise disposed of. (218) This type of process may be useful when the goal is not to treat a particular volume of material, but instead, to skim or glean useful water from a particular source. For example, where drinking water is desired from a river or where watering water is desired to be captured from sewage.

The above described system may reflect a relatively basic system, while FIG. 3 shows a more involved system with additional loops and options. Nonetheless, the basic process flow shown in FIGS. 1 and 2 remain consistent with the piping and instrument diagram of FIG. 3. Each of the various portions of the system may be described briefly below while highlighting the aspects that add to the that shown in FIGS. 1 and 2.

With respect to the process tank 114, as shown in FIG. 3, an additive basin, bin, or vat may be in communication with the process tank 114 for providing additives, such as sulfuric acid, for example. In addition, meters or other measurement devices may be provided for measuring, inter alia, conductivity, temperature, pH, total dissolved solids (TDS), or other properties of the material in the process tank. These measurements may be helpful in determining if and/or when to drain some or all of the material in the process tank 114 or if and/or when to provide any additive to the material. For example, when the concentration of the material in the process tank 114 exceeds a suitable level based on the conductivity readings, some or all of the tank 114 may be drained or diluted, or an additive may be provided. With respect to dilution, as also shown in FIG. 3, in some embodiments, a return line from the permeate portion of the system may be provided to the process tank 114 for cleaning the tank, diluting the material in the tank, or for other purposes. As also shown, an incoming leachate feed line from the collection tanks may bypass the process tank 114 and head directly to the pre-treatment portion 104. As such, where a continuous feed approach is used or where the process tank 114 is not needed for adjusting the chemistry of the material or otherwise not needed, the process tank 114 may be bypassed.

Turning now to the pre-treatment portion 104 of the system, FIG. 3 shows lines intervening in this process from the permeate portion of the system. That is, the lines extend from a cleaning/flush tank holding permeate that has been received from the fine filtration process. As shown, valves that control receipt of leachate or other process material from the process tank 114 or area may be closed or partially closed and valves that control the flow of permeate into the pre-treatment area 104 may be opened or partially opened. This may allow the fine filtration portion 106 of the system 100 to be flushed or accessed by relatively clean flush permeate or a combination of clean flush permeate and the incoming leachate. In some embodiments, as also shown, the cleaning/flush tank may be in communication with a series of additives particularly adapted for cleaning and/or disinfecting the tubular membranes 124. For example, the cleaning/flush tank may be in communication with a series of vats, bins, basins, or other tanks including, for example, an acid tank, a caustic tank, a sodium metabisulfate tank, and/or a liquid detergent tank. Accordingly, a particular chemistry of the clean/flush tank may be established by adding one or more additives and that material may be routed through the pre-treatment portion 104 and the fine filtration process 106 and used alone or in conjunction with incoming leachate to clean the pre-treatment system and/or the fine filtration system. This aspect of the system 100 may be helpful for disinfecting and/or otherwise treating the system 100 depending on the nature of the material being treated.

Referring now to the concentrate lines returning to the process tank 114 from the fine filtration system 106, as shown, a line may extend from this concentrate line into the clean/flush tank. That is, a line, including a valve, may extend into the clean/flush tank allowing for the user to selectively direct some portion or all of the concentrate from any one or several of the concentrate lines to the clean/flush tank. Accordingly, when disinfecting, the portion of the disinfecting water that does not permeate through the membranes may be returned to the clean/flush tank for reuse or cycling through again.

It is to be appreciated that the present system may be particularly advantageous due to being a single-stage treatment system that can receive remarkably dirty incoming fluid and produce remarkably clean permeate in a single pass. For example, in some embodiments, the incoming fluid may contain a total dissolved solids content of approximately 50,000 mg/liter, a chemical oxygen demand of 100,000 mg/liter, a total solids content of 10-25%, and a total suspended solids content of 20,000-30,000 mg/liter. Remarkably, upon treatment with the described system, the permeate may include less than 10 mg/liter of total dissolved solids, less than 50 mg/liter chemical oxygen demand, approximately 0-10% total solids and approximately 0% total suspended solids. It was a surprising result that such remarkable results could be obtained from a single pass system as it was understood that such a fine membrane filtration system would clog if presented with material having such high solids content and, as such, it was expected that little to no permeate would be received after a short period of time. It is believed that the combination of high solids and high velocity function to scour the inner surface of the membranes allowing the membranes to continue to allow permeate therethrough.

Moreover, the adjustment mechanism functions to allow adjustability with a system previously not known to be adjustable. That is, tubular membrane filters have not been thought to be adjustable. Rather, where a differing degree of filtration is desired, the membrane may be traded for another membrane with a differing filtration profile. In the present system, a range of adjustment may be provided allowing a single membrane to be used for a wider range of filtration. That being said, when the range desired is outside the range of adjustability of the membranes, the present system allows for trading out of the membrane for another membrane by removing the end cap, end washer and end bushing and removing the membranes from the casing.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A single-stage water treatment system, comprising:
a fine filtration module configured for receiving process material with a high suspended or dissolved solids content and for producing a concentrate and a permeate, the fine filtration module comprising:
an elongate housing member;
a plurality of tubular membranes arranged within the elongate housing member and comprising elongate tubular members having membranous sidewalls with a selected permeability;
a pair of end caps configured for controlling the flow of the process material within the plurality of tubular membranes; and
an adjustment mechanism configured to adjust the elongation of the plurality of tubular membranes thereby adjusting the permeability thereof.
